(19) United States
(12) Patent Application Publication
(10) Pub. No.: US 2011/0243697 A1
(43) Pub. Date: Oct. 6, 2011

(54) Apparatus and Method for Transferring Freight

(76) Inventors: Gregory Lee Braun, Bermuda Dunes, CA (US); Preston Pete Richter, El Centro, CA (US)

(21) Appl. No.: 12/797,725

(22) Filed: Jun. 10, 2010

Related U.S. Application Data
(60) Provisional application No. 61/321,367, filed on Apr. 6, 2010.

(51) Int. Cl. B60P 1/00

(52) U.S. Cl. 414/506; 414/812

(57) ABSTRACT

The present disclosure provides an apparatus to assist in unloading freight from a transport vessel using a movable winch drum positioned operably proximate an underside of the floor of the transport vessel, a least one roller connectable to a transom of the transport vessel, the at least one roller being dimensioned to receive a cable, the cable being connected to the winch drum at a first end, and a shaped bulkhead connected to the cable at a second, the bulkhead being positioned at a bow of the bed, behind the freight, wherein when the movable winch drum is actuated, the shaped bulkhead is configured to pull freight towards an aft of the bed for unloading. A method for the same is also provided.

### CROSS-REFERENCE TO RELATED APPLICATIONS

The present Utility patent application claims priority benefit of the U.S. provisional application for patent Ser. No. 61/321,367, filed on Apr. 6, 2010 and entitled System and Method for Transferring Freight, under 35 U.S.C. 119(e). The contents of this related provisional application are incorporated herein by reference for all purposes.

### BACKGROUND

The invention relates to the shipping of freight (e.g., commodities). More particularly, the invention relates to the transfer of commodities to and from shipping containers or other modes of transport.

The brokering of commodities has been practiced for centuries throughout the world. The growth of shipping demand has fueled the drive for efficiencies in the systems and method used to ship goods from the supplier to the buyer, especially considering that goods may be transferred to and from different modes of transport quite frequently. For example, a product may be produced in a factory in Singapore, packaged on-site and loaded into a transport vessel such as a truck or container. The truck or container may then be unloaded or transferred at a harbor port, where it may then be loaded onto a container ship. The container ship, after crossing thousands of miles of ocean, may then arrive at another harbor port, for example, where it is unloaded from the container ship. The goods must then be loaded into another transport vessel, transported to a warehouse, and again, unloaded. From the warehouse, the goods may again be loaded into yet another transport vessel and taken to the retail location where it is eventually purchased by a consumer.

Typically, each time goods are loaded or unloaded to a transport vessel, depending upon the location of the goods, a stationary or mobile truck dock or truck dock ramp must be used. In operation, a transport vessel, such as a container truck or box truck, may back into a gate at a shipping dock, which allows forklifts or other lift trucks to drive into the container to retrieve the goods. However, this method is ineffective if there is no truck dock available. For this situation, various ramps have been proposed. For example, U.S. Pat. No. 5,795,125 describes an extendable ramp assembly for pickup trucks and the like which describes a platform assembly having a hollow interior that is bolted to the floor the bed. A sliding platform is adjustably positioned within the platform assembly to allow for adjusting the angle of incline of an extendable ramp which is attached thereto. The sliding platform is designed to have a minimal thickness so that compression of the platform assembly does not affect movement of the sliding platform. A hinge plate is connected to the ramp to allow for a relatively smooth and continuous surface between the ramp and the top surface of the platform assembly.

Various devices mounted to container trucks have been also been proposed that remove the whole container from the truck. For example, U.S. Pat. No. 4,111,321 describes a mechanism to “dump” a container from a truck bed onto the ground comprising a rectangular frame mounted on the load carrying chassis of a vehicle by lugs. A pair of beams are pivoted on the frame at the end thereof which is towards the rear of the vehicle. Each beam is formed with an elongated guide, with the two guides mutually parallel and parallel to the plane of the frame. However, even though the container is unloaded off a truck, the container itself must still be unloaded with goods.

Various hoists have also been used in the past to unload goods from the bed of truck. For example, U.S. Pat. No. 7,300,239 describes a hoist for elevating cargo onto the bed of a truck which includes a frame which may be mounted to the truck bed, a platform or container which is connected to the frame by a pivoting arm, and an arrangement of linkages for rotating the arm to position the platform either on the truck bed or on a loading and unloading position resting on the ground behind the truck. A hydraulic ram is connected to the arm via the linkages, with the linkages being arranged to increase the effective “flow” of the arm to provide a long travel distance of the arm. This type of hoist is typically appropriate for an open bed truck, such as a pick-up truck.

However, the devices and methods discussed above are not particularly operable for unloading container trucks, and may be expensive, cumbersome and not easily removable.

### BRIEF DESCRIPTION

The present disclosure describes an apparatus and method for unloading freight from a transport vessel.

In an embodiment, the invention provides a winch assembly for mounting to a truck, the truck having a bed with a bow, and aft, and an underside, the winch assembly comprising a winch drum mounted to the the truck and configured to provide a pulling force, a cable line operably connected to the winch drum at a first end, at least a first portion of the cable line being coiled around the winch drum, at least one roller block attached to the aft of the truck, the roller block being configured to receive and maintain the cable line in a position, and a shaped bulkhead connected to a second end of the cable line, the shaped bulkhead being positioned towards the bow of the bed of truck, wherein when the winch drum is actuated, the bulkhead is configured to be pulled towards the aft of the bed of the truck.

In another embodiment, the invention provides an apparatus to assist in unloading freight from a transport vessel, the transport vessel having a floor defining a bed for supporting freight, the apparatus comprising a movable winch drum positioned operably proximate an underside of the floor of the transport vessel, a least one roller connectable to a transom of the transport vessel, the at least one roller being dimensioned to receive a cable, the cable being connected to the winch drum at a first end, a shaped bulkhead connected to the cable at a second, the bulkhead being positioned at a bow of the bed, behind the freight, wherein when the movable winch drum is actuated, the shaped bulkhead is configured to pull freight towards an aft of the bed for unloading.

In another embodiment, the invention provides a method for unloading freight from a transport vessel comprising fixing a winch drum proximate an underside of the transport vessel, providing a cable attached to the winch drum at a first end, attaching at least one roller to an aft of the transport vessel, the roller configured to receive the cable and guide the cable down a center line of the transport vessel, providing a shaped bulk head at a bow of the transport vessel positioned behind the freight, connecting a second end of the cable to the shaped bulkhead, actuating the winch drum to provide a pulling force on the bulkhead, the bulkhead being configured to move the freight towards the aft of the transport vessel.

Other features and advantages of the disclosure will become apparent by reference to the following description taken in connection with the accompanying drawings.

### BRIEF DESCRIPTION OF THE DRAWINGS

Reference is now made briefly to the accompanying drawings, in which:

FIG. 1 is a side view of a container truck having a winch assembly mounted thereto in accordance with an embodiment of the present invention.

FIG. 2 is perspective view of the open container of the container truck and an apparatus to assist in unloading freight in accordance with an embodiment of the present invention.

FIG. 3 is a series of frames, shown as a side view, of the container truck of FIG. 1, taken over a predetermined period of time (At), with each frame showing a different time period, in accordance with another embodiment of the present invention.

FIG. 4 is a side view of a container truck and an apparatus to assist in unloading freight in accordance with another embodiment of the present invention.

FIG. 5 is a flow chart illustrating a step-wise method for unloading freight from a transport vessel in accordance with another embodiment of the present invention.

Like reference characters designate identical or corresponding components and units throughout the several views, which are not to scale unless otherwise indicated.

### DETAILED DESCRIPTION

One embodiment of the present invention provides a winch assembly for mounting to a truck comprising a winch drum mounted to the underside of the truck and configured to provide a pulling force, a cable line operably connected to the winch drum at a first end, at least a first portion of the cable line being coiled around the winch drum, at least one roller block attached to the aft of the truck, the roller block being configured to receive and maintain the cable line in a position, and a shaped bulkhead connected to a second end of the cable line, the shaped bulkhead being positioned towards the bow of the bed of truck, wherein when the winch drum is actuated, the bulkhead is configured to be pulled towards the aft of the bed of the truck.

Specific configurations and arrangements of the claimed invention, discussed below with reference to the accompanying drawings, are for illustrative purposes only. Other configurations and arrangements that are within the purview of a skilled artisan can be made, used, or sold without departing from the spirit and scope of the appended claims. For example, while some embodiments of the invention are herein described with reference to unloading freight from the bed of a container trucks, a skilled artisan will recognize that embodiments of the invention can be implemented in other settings such as unloading pick-up trucks, flat bed trucks, and the like. A particular advantage afforded by each embodiment of the present invention is the ability to unload cargo without the need or use of a dock. In operation, a forklift or bail clamp lift may unload a full load of freight from a container truck, e.g., a 42 foot container truck, without ever using a dock or ramp.

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features. As used herein, the term “approximately” may be defined as a given measurement varying as much as 10 percent of the total measurement in any direction. As used herein, the term “freight” may be used to define any cargo, good, stowage or commodity that is transported in a transport vessel, specifically, agricultural products such as iron ore, crude oil, coal, ethanol, salt, sugar, coffee beans, soybeans, copper, rice, wheat, gold, silver, palladium, and platinum. Even more particularly, the term “freight”, for the purposes of this application, may refer to hay (e.g., alfalfa hay, sudan grass, klein grass, bermuda hay and straw). As used herein, the term transport vessel may be used to define any type of vessel in which goods are transported, including but limited to containers, container trucks, cargo vans, flat bed trucks, ocean liners, and like. As used herein, the term “transfer” may be used to define the removal of freight from a transport vessel. As used herein, the term “winch drum” or “winch assembly” is used to define any element capable of providing an actuated pulling force.

One embodiment of the present invention relates to a winch assembly for mounting to a truck and configured to assist a user in unloading freight from the bed of a container truck. The winch assembly may comprise a winch drum mounted to the underside of the truck and configured to provide a pulling force, a cable line operably connected to the winch drum at a first end, at least a first portion of the cable line being coiled around the winch drum, at least one roller block attached to the aft of the truck, the roller block being configured to receive and maintain the cable line in a position, and a shaped bulkhead connected to a second end of the cable line, the shaped bulkhead being positioned towards the bow of the bed of truck, wherein when the winch drum is actuated, the bulkhead is configured to be pulled towards the aft of the bed of the truck.

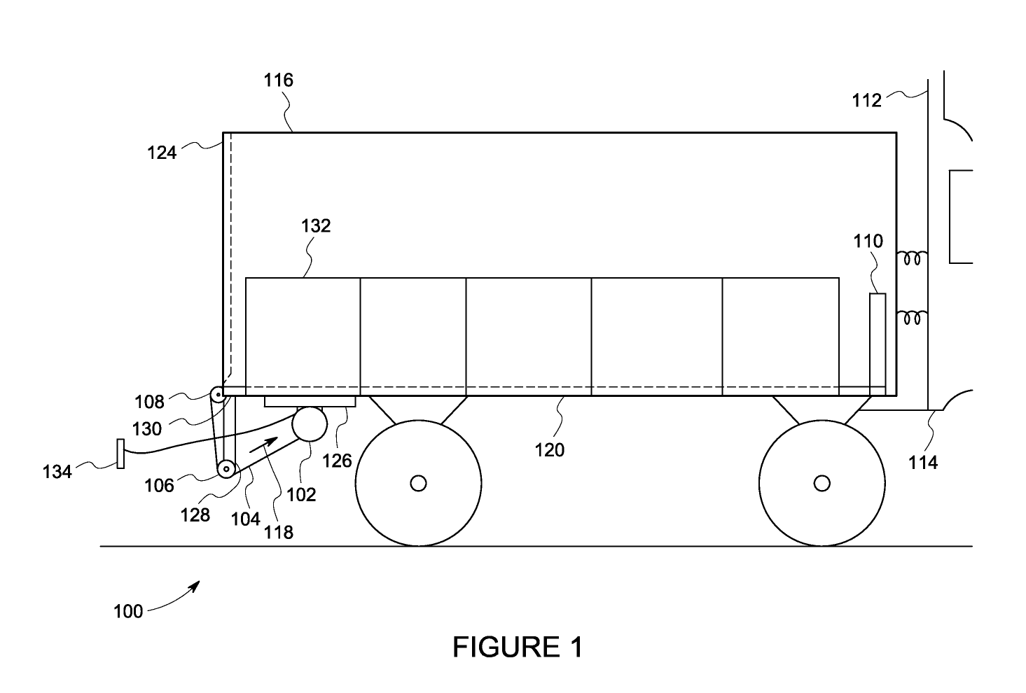

With reference now to FIG. 1, in an exemplary embodiment of the present invention, a winch assembly mounted to a container truck is shown generally at reference numeral 100. The winch assembly may comprise a winch drum 102, a cable 104, a first and second roller block 106, 108 and shaped bulkhead 110. The exemplary winch assembly 100 may be used in conjunction with a transport vessel 112, which may comprise container truck 114 having freight container 116 attached thereto.

The winch drum 102 may comprise a hydraulic winch, a pneumatic winch, or an internal combustion winch depending upon the user's desire as for the amount of pulling power. In an exemplary embodiment of the present invention, an industrial winch comprising a rated pulling power of, e.g., minimally approximately 25,000 lbs, running on 24 volts. Of course, the pull rating can vary greatly (e.g., 5 lbs-100,000 lbs) depending upon the weight of the freight to be unloaded. The winch drum 102 may further comprise a handheld remote 134 operable by user and configured to actuate the winch drum 102 to provide a pulling force in the direction of arrow 118.

The winch drum 102 may be mounted, via stabilization plate 126, to the underside 120 of the container 116 at an aft 124 of the truck 114. The winch drum 102 may be attached to the stabilization plate 126 with a suitably strong attachment member, such as rivets, industrial screws, and the like. The stabilization plate 126 may, in turn, may be mounted to the underside 120 of the container 116 of the truck 114. In optional embodiments, the stabilization plate may comprise removable brackets (not shown) such that the stabilization plate may be removably attached to the underside 120 of the container 116 of the truck 114.

Referring still to FIG. 1, a cable line 104 (also referred to herein as “cable”) may be connected to the winch drum 102 at a first end, at least a portion of the cable 104 being coiled around the winch drum 102. The cable line 104 may comprise a galvanized stainless steel cable of suitable strength and length to accommodate a desired load. In an exemplary embodiment, the cable 104 may have a diameter of ⅜ in, be 7 stranded, have 19 wires per strand, have a load capacity that corresponds to the weight of the frieght, and further comprise a galvanized zinc coating. The cable 104 may also comprise a non-recoiling cable for safety and efficacy purposes.

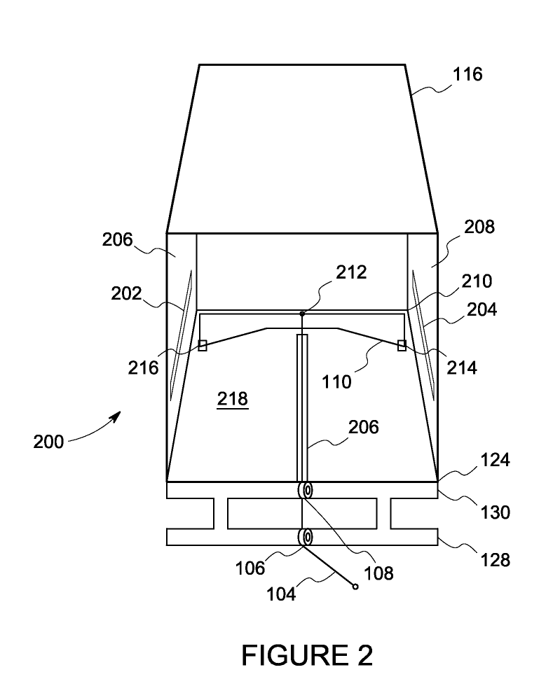

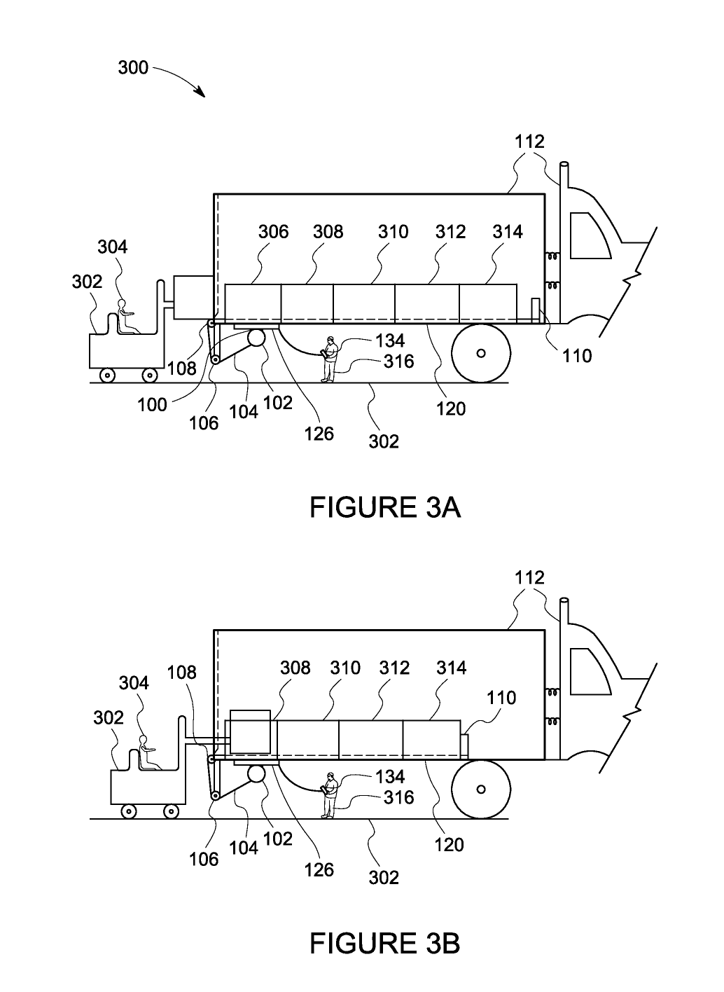

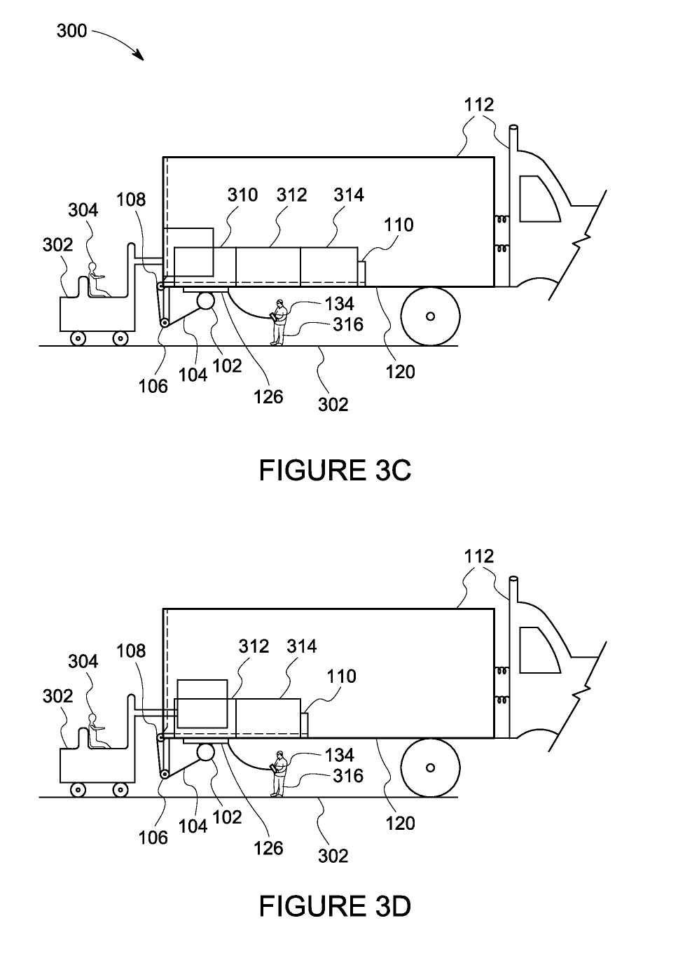

A first and second roller block 106, 108 may be attached to an aft 124 of the container 116, the roller blocks 106, 108 being configured to receive and maintain the cable 104 in a position, while also altering the vector of force. The first roller block 106 may be attached to a lower transom rail 128 of the truck 114, while the second roller block 108 may be attached to an upper transom rail 130. The roller blocks 106, 108 may be removably attached to the upper and lower transom rails 128, 130 through the use of clamps or brackets (not shown). The roller blocks 106 and 108 may comprise a pulley block having a single sheave, the sheave being dimensioned to correspond to the diameter of the steel cable 104, and thus, configured to receive the steel cable 104. The sheave is rotatable and, in operation, is configured to shift the vector of pulling force supplied by the drum winch 102, initially at plus at least 90 degrees (e.g., 110 degrees) for the first roller, and plus an additional 90 degrees at the second roller. As a result, the pulling force supplied by the winch drum 102 may be used to pull freight 132 towards an aft 124 of the transport vessel 112, via the shaped bulkhead 110, which will be discussed in greater detail with relation to FIGS. 2 and 3.

With reference now to FIG. 2, a perspective view of the open container of the container truck and an apparatus to assist in unloading freight in accordance with an embodiment of the present invention is shown generally at reference numeral 200. In this exemplary embodiment, the winch assembly may further comprise a pair of guide rails 202, 204 and channel 206.

Guide rails 202 and 204 may be removably mounted to each side wall 206, 208 of the container 126. The guide rails 202, 204 may be mounted in a known manner, e.g., via rivets, screws, adhesives and the like. The guide rails 206, 208 may be mounted parallel with a center line of the container 116, running from the bow 210 to the aft 124. The guide rails 202, 204 may be formed from known plastics or metals with suitable strength to withstand contact from the type of freight being shipped. In an exemplary embodiment of the present invention, the guide rails 202, 204 may be formed from Polytetrafluoroethylene (e.g., Teflon® manufacture by DuPont and Co.). The guide rails 202, 204 may have constant thickness, and be configured to shield the side walls 206, 208 from the freight (shown in FIG. 1) as it is being extracted from the container 116. The guide rails 202, 204 may be further configured to smooth the transition and stabilize the freight towards an aft 124 of the container during the extraction of freight. In an optional embodiment, the guide rails 202, 204 may be mounted adjacent the center line of the container towards the aft section 124 to shield the walls at the aft of the container 126 during extraction of the freight. In another optional embodiment, the guide rails 202, 204 may be sloped, that is, having a decreasing thickness from the bow 210 to the aft 124, which in operation, may provide additional space for the clamps of a bail clamp to retrieve the freight.

Referring still to FIG. 2, a channel 206 may be located at the center line of the truck, running from the bow 210 to the aft 124, and dimensioned to correspond to the circumference of the cable 104. The channel 206 may be configured to allow the able to run flush with the bed of the container 126. In an optional embodiment, no channel may be provided, and the cable 104 may lie on the floor, located between any freight that is in the container 126.

As can best be seen in FIG. 2, the first roller block 106 may be attached to a lower transom rail 128 of the truck, while the second roller block 108 may be attached to an upper transom rail 130. Each roller block 106, 108 may be linearly mounted to the transom rails 128, 130 of the container truck, and roller blocks 106, 108 operating in tandem to guide the cable down the center line of the container 126.

Referring still to FIG. 2, the bulkhead 110 may have an inwardly sloped bottom edges such that the height of the bulkhead 110 is greater at each edge than at the middle portion. The bulkhead 110 is optimally configured to “glide” down the bed of the truck when the winch drum 102 is actuated. The exemplary shape of the bulkhead is provided to distribute pressure to the outside edges of the cargo, to center the cargo towards the centerline and away from the walls of the container to form a tight package before transfer and to “pinch” the freight together for less complicated unloading process. The bulkhead 110 may further comprise an attachment ring 212 configured for attachment and detachment of the cable 104. In an optional embodiment, glide members 214 and 216 may be attached to the bottom edges of the bulkhead 110, and configured to reduce friction between the bulkhead 110 and bed 218 of the container 126 when the winch drum 102 is actuated. In an optional embodiment, the bulkhead may be further provided with additional or supplementary guide members that may be connected the sides of the bulkhead 110 and configured to reduce friction between the bulkhead 110 and the side walls 206, 208. In other optional embodiments, the guide members 216 and 218 may comprise removable wheels.

Referring now to FIG. 3, FIGS. 3a-3d are a series of frames, taken in side view, of a winch assembly and container truck having freight located therein over a predetermined period of time (Δt), with each frame showing a different time period is shown generally at reference numeral 300.

The device as shown in FIG. 3a, as in FIGS. 1 and 2, may comprise a winch assembly 100 mounted to an underside 120 of a container truck 112. The winch assembly may comprise a winch drum 102, a cable 104, a first and second roller block 106, 108 and shaped bulkhead 110. The winch drum 102 may be actuated via remote 132 to provide a pulling power. In the exemplary embodiment shown in FIGS. 3a-d, a bail clamp 302 is being operated by a user 304 to unload a first bale of hay 306, which may be a packaged in, for example, a hay sleeve or a hay wrap. As shown in FIG. 3a, the container 116 may contain hay bales 306-314. Another user 316 may operate the remote 134 which is configured to actuate the winch drum 102. However, a second user is not required to operate the remote 134, as the first user 304 may operate the remote 134 as well.

In operation, the container truck 112 may pull into a drop off zone which does not have a loading dock, and thus, may be unloading the truck 112 from the ground 302. The bail clap 302 may be used to unload hay bale 306. After unloading hay bale 306, the user 316 may actuate the winch drum 102 to pull the shaped bulkhead 110 towards the aft of the truck bed 120, thus pulling the hay bale 308 to an edge of the bed so that the clamp may unload hay bale 308, as shown in FIG. 3b. The bale clamp 302 can then unload 308 and return for hay bale 310. The user 316 may then again actuate the winch drum 102 and, using the shaped bulkhead 110, pull the hay bale 310 towards the edge of the bed so that the bale clamp 302 can reach hay bale 110. In FIG. 3d, the same process as described with reference to FIGS. 3a-c may be used to unload hay bale 312.

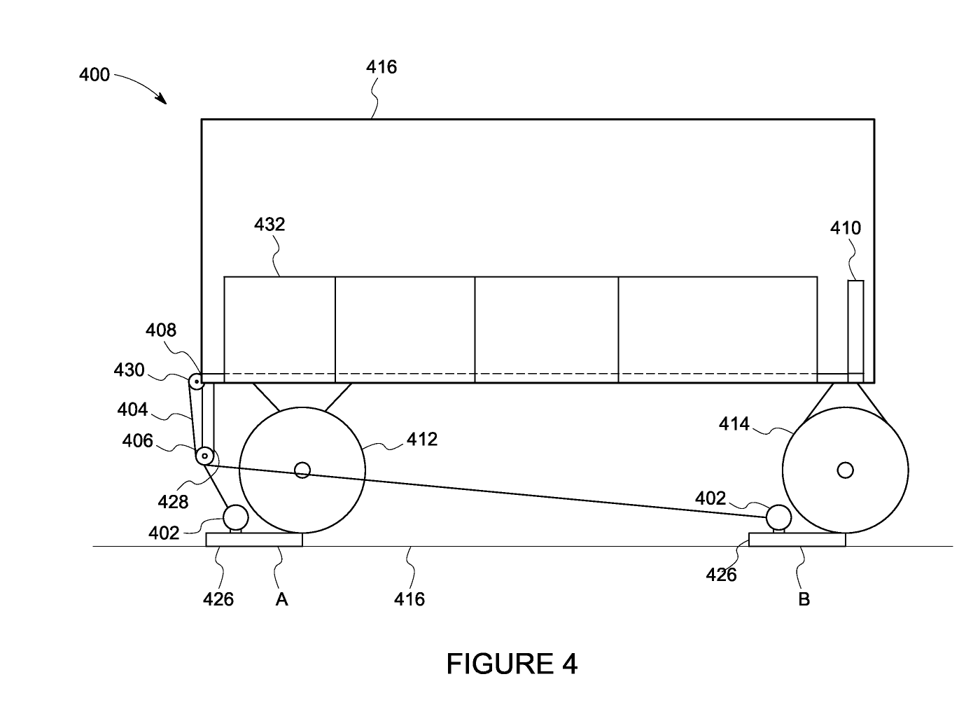

With reference now to FIG. 4, an apparatus to assist in unloading freight from a transport vessel in accordance with another embodiment the present invention is shown generally at 400. The apparatus 400 of this exemplary embodiment may be, it its entirety, attachable and detachable to a container truck. The apparatus may comprise a movable winch drum 402 mounted to a stabilization plate 426, two rollers 406 and 408 connectable to an upper and lower transom bar 428, 430, and a shaped bulkhead 410 connected to cable 404. In this exemplary embodiment, the apparatus 400 may be stored at a freight transfer location and used with any truck that is hauling cargo and arrives at the location. Furthermore, in this exemplary embodiment, a user does not have to mount the assembly 400 to the truck, except for to attach the roller blocks 406, 408 to the transom rails 428, 430.

Still with reference to FIG. 4, in operation, at a transfer station, the user may place the stabilization plate on the ground 416 proximate a rear truck tire 412. The truck may then roll onto the stabilization plate 426 to stabilize the winch drum 402 between the tire and the ground so that, when actuated, the winch drum 402 is secure and thus able to pull freight 432 from the container 416, as described with reference to FIGS. 3a-d. In this regard, the stabilization plate 426 may be shaped and dimensioned to receive a wheel 412 of container truck, which are supplied in known sizes.

As can be seen in FIG. 4, two optional placements, A and B, may be used. In placement A, the stabilization plate 426 may be secured under the rear tire 412 of the truck, while in placement B, the stabilization plate 426 may be secured under front tire 414. If the stabilization plate 426 is secured under the front tire, a cable cab be provided in the van and can be directly attached or spooled on the winch drum 402. In this embodiment, the winch drum would not need to be provided with a cable. Also, less cable would be needed, which minimizes safety risks due to cable whip, breakage, etc. Optionally, the stabilization plate may be mounted to the ground at a predetermined unloading area such as a yard or harbor.

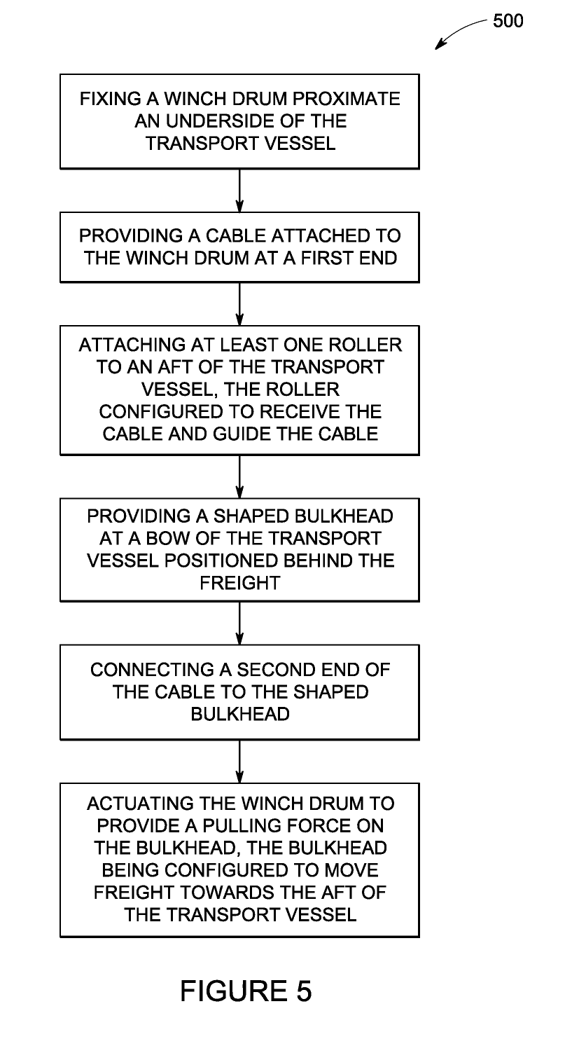

Referring now to FIG. 5, there is shown a flow chart to better help illustrate a method for unloading freight from a transport vessel is shown generally at 500. While the flowchart shows an exemplary step-by-step method, it is to be appreciated that a skilled artisan may rearrange or reorder the steps while maintaining like results.

Fixing a winch drum proximate an underside of the transport vessel step 502 may comprise providing a winch drum such as the winch drum described with relation to

FIG. 1, and fixing the winch drum either to an underside of transport vessel or under the front or rear tire such as placements A and B shown in FIG. 4. Furthermore, the winch drum may be mounted to a stabilization plate, the stabilization plate being mounted to the underside of the transport vessel. Optionally, the stabilization plate may comprise removable brackets such that the stabilization plate may be removably attached to the underside of the transport vessel.

Providing a cable attached to the winch drum at a first end step 504 may comprise providing a steel cable such as one described with reference to FIG. 1, that is, a cable line connected to the winch drum at a first end, at least a portion of the cable being coiled around the winch drum. The cable line may comprise a galvanized stainless steel cable, may have a diameter of ⅜ of an inch, and further comprise a galvanized zinc coating. The cable may also comprise a non-recoiling cable for safety and efficacy purposes.

Attaching at least one roller to an aft of the transport vessel, the roller configured to receive the cable and guide the cable down a center line of the transport vessel step 506 may comprise providing two roller blocks linearly mounted to an aft of the transport vessel, the roller blocks being configured to receive and maintain the cable in a position, while also altering the vector of force. The roller blocks may comprise a pulley block having a single sheave, the sheave being dimensioned to correspond to the diameter of the steel cable, and thus, configured to receive the steel cable. As described with reference to FIG. 1, the sheave is rotatable and, in operation, is configured to shift the vector of pulling force supplied by the drum winch, initially at plus at least 90 degrees (e.g., 110 degrees) for the first roller, and plus an additional 90 degrees at the second roller.

Providing a shaped bulkhead at a bow of the transport vessel positioned behind the freight, step 508 may comprise providing a bulkhead having inwardly sloped bottom edges such that the height of the bulkhead is greater at each edge than at the middle portion. The bulkhead may comprise an attachment ring configured for attachment and detachment of the cable, step 510. Optionally, glide members may be provided and attached to the bottom edges of the bulkhead to reduce friction between the bulkhead and the bed of the container.

Actuating the winch drum to provide a pulling force on the bulkhead, the bulkhead being configured to move the freight towards the aft of the transport vessel step 512 may comprise actuating the winch drum via remote control operated by a user. When actuated, the winch drum is configured to provide a pulling power which is transferred, via the steel cable, to the bulkhead to pull freight towards a region of the bed of the container, typically the aft of the container at the door. In operation, the container truck may pull into a unloading zone which does not have a loading dock, and thus, may unload the truck.

While the present invention has been described in connection with what are presently considered to be the most practical and preferred embodiments, it is to be understood that the present invention is not limited to these herein disclosed embodiments. Rather, the present invention is intended to cover all of the various modifications and equivalent arrangements included within the spirit and scope of the appended claims.

Although specific features of various embodiments of the invention may be shown in some drawings and not in others, this is for convenience only. In accordance with the principles of the invention, the feature(s) of one drawing may be combined with any or all of the features in any of the other drawings. The words “including”, “comprising”, “having”, and “with” as used herein are to be interpreted broadly and comprehensively and are not limited to any physical interconnection. Moreover, any embodiments disclosed herein are not to be interpreted as the only possible embodiments. Rather, modifications and other embodiments are intended to be included within the scope of the appended claims.

What is claimed is:

1. A winch assembly for mounting to a truck, the truck having a bed with a bow, and aft, and an underside, the winch assembly comprising:
a winch drum mounted to the truck and configured to provide a pulling force;
a cable line operably connected to the winch drum at a first end, at least a first portion of the cable line being coiled around the winch drum;
at least one roller block attached to the aft of the truck, the roller block being configured to receive and maintain the cable line in a position; and
a shaped bulkhead connected to a second end of the cable line, the shaped bulkhead being positioned towards the bow of the bed of truck;
wherein when the winch drum is actuated, the bulkhead is configured to be pulled towards the aft of the bed of the truck.

2. The winch assembly of claim 1, wherein the truck comprises a container truck having a container attached to the bed of the truck and a transom located at the aft of the truck.

3. The winch assembly of claim 2, further comprising a pair of guide rails mounted to each of wall of the container, the guide rails being configured to slope towards the aft and further configured to stabilize freight on the bed of the truck.

4. The winch assembly of claim 1, wherein the winch drum comprises a hydraulic winch, a pneumatic winch or an internal combustion driven winch and is user operable via remote control.

5. The winch assembly of claim 1, wherein the winch drum is mounted to a stabilization plate, the stabilization plate comprising bores for mounting to an underside or a truck at the aft end.

6. The winch assembly of claim 5, wherein the stabilization plate is mounted to the underside of the truck at the bow end.

7. The winch assembly of claim 2, wherein the at least on roller block comprises two roller blocks, each roller block being linearly mounted to the transom of the container truck, wherein the roller blocks operate in tandem to guide the cable down a center line of the container.

8. The winch assembly of claim 1, wherein the truck bed further comprises a channel located at a center axis from the bow to aft, dimensioned to correspond to the circumference of the cable and configured to allow the cable to run flush with the bed of the truck.

9. The winch assembly of claim 1, wherein the bulkhead comprises an attachment ring configured for the attachment and detachment of the cable.

10. The winch assembly of claim 1, wherein the bulkhead comprises an inwardly sloped bottom edge such that the height of the bulkhead at each edge is greater than the height of the bulkhead at a middle portion.

11. The winch of assembly of claim 1, wherein the bulkhead further comprises a glide member attached to the bottom edge, the glide member configured to reduce friction between the bulkhead and the bed of the truck.

12. The winch assembly of claim 11, wherein the glide member comprises removable wheels.

13. An apparatus to assist in unloading freight from a transport vessel, the transport vessel having a floor defining a bed for supporting freight, the apparatus comprising:
a movable winch drum positioned operably proximate an underside of the floor of the transport vessel;
a least one roller connectable to a transom of the transport vessel, the at least one roller being dimensioned to receive a cable, the cable being connected to the winch drum at a first end,
a shaped bulkhead connected to the cable at a second, the bulkhead being positioned at a bow of the bed, behind the freight;
wherein when the movable winch drum is actuated, the shaped bulkhead is configured to pull freight towards an aft of the bed for unloading.

14. The apparatus of claim 13, wherein the movable winch drum is mounted to a stabilization plate, the stabilization plate being configured to receive at least one tire of the transport vessel.

15. The apparatus of claim 13, wherein the movable winch drum comprises a hydraulic winch, a pneumatic winch or an internal combustion driven winch.

16. The apparatus of claim 13, wherein the at least one roller comprises an adjustable clamp mounted thereto configured to attached to the transom of transport vessel.

17. The apparatus of claim 13, wherein the bulkhead comprises an attachment ring configured for the attachment and detachment of the cable.

18. The apparatus of claim 13, wherein the bulkhead comprises:
an inwardly sloped bottom edge such that the height of the bulkhead at each edge is greater than the height of the bulkhead at a middle portion; and
a glide member attached to the bottom edge, the glide member configured to reduce friction between the bulkhead and the bed of the truck,
wherein the glide member comprises removable wheels.

19. The winch assembly of claim 11, wherein the winch assembly is mounted to the earth at a predetermined place.

20. A method for unloading freight from a transport vessel comprising:
fixing a winch drum proximate an underside of the transport vessel;
providing a cable attached to the winch drum at a first end;
attaching at least one roller to an aft of the transport vessel, the roller configured to receive the cable and guide the cable down a center line of the transport vessel;
providing a shaped bulk head at a bow of the transport vessel positioned behind the freight;
connecting a second end of the cable to the shaped bulkhead;
actuating the winch drum to provide a pulling force on the bulkhead, the bulkhead being configured to move the freight towards the aft of the transport vessel.
